(19) United States
(12) Patent Application Publication
(10) Pub. No.: US 2002/0059396 A1
(43) Pub. Date: May 16, 2002

(54) Apparatus and a process for the retrieval of data in the case of a faulty request on a server in the internet

(76) Inventors: Dipl.-Ing. Rene Holzer, Merseburg (DE); Ramona Wonneberger, Halle (DE)

Correspondence Address: J. D. Harriman II, COUDERT BROTHERS, 23rd Floor, 333 South Hope Street, Los Angeles, CA, 90071, US

(21) Appl. No.: 09/966,943

(22) Filed: Sep. 27, 2001

(30) Foreign Application Priority Data
Sep. 28, 2000 (DE) 100 48 112.4

(51) Int. Cl. G06F 15/16

(52) U.S. Cl. 709/217

(57) ABSTRACT

This invention relates to an apparatus and a process for the retrieval of alternative data in the case of a faulty request by a client on a server in a network (such as the internet). Included is a network interface (12) which enables the stream of data between a client (11) and server (20) to be analysed. The network interface (12) has a processing unit (18) which checks the traffic of data in the case of a faulty request by the client. The error messages from the server will be blocked and replaced by alternative data, based on the nature of the search. This alternative data (19) will then be sent to the client (11) by the network interface (12).

### BACKGROUND OF THE INVENTION

1. Field of the Invention

The present invention relates to an apparatus and process for retrieving data in the case of a faulty request on a network.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

False internet addresses are often typed in during use of a browser on the internet. This causes the DNS (Domain Name Service) server to send error messages. These error messages are received by the browser, which then loads an existing page. To bring up data in the internet the user must type in specific addresses, or identifiers. A server then takes these requests and tries to match them exactly with the data entered by the user.

TCP/IP is the standard communication protocol in the internet. Every internet user receives a clear, unambiguous IP address. Because these IP addresses are made up of combinations of numbers (and are therefore more difficult to remember and use) there is a service in the internet that assigns names to IP addresses. This server is called “Domain-Name-Service”(DNS). This service changes a name on the internet into an IP address. The IP address will then be used to send an request directly to the server which is being sought. For example, the IP address 193.45.2.34 represents MICROSOFT.COM. The manual input of the address, MICROSOFT.COM, in a browser will be sent to a DNS server which then returns the proper IP address. After the answer of the DNS-Server the connection to the Microsoft-server is established.

However, if the user types in an incorrect address, for example MCROSOF.COM, the DNS server will deliver a message that an error has occurred. This error message is then sent on to the user. The user finds out that his or her request could not be answered/fulfilled. Besides typing in the wrong addresses, the mentioned problem occurs when a web page has been moved or erased. Again the user would only receive a message that an error had occurred. The same would be true if the user tries to access web pages for which he or she does not have access permission.

Apart from the internet addresses, this description of events pertains to all kinds of data found on the internet, such as pictures, video and audio material, and information.

### SUMMARY OF THE INVENTION

The task of the invention is to make available an apparatus and a process which extracts and classifies the error messages. This is done in order to replace the error message with alternative data such as alternative addresses, advertisement banners, etc. To solve this task, a network-interface is used. The network interface is able to analyse the stream of data between the client and the server because it uses independent standards, and especially because of the apparatus which will be used to replace error messages with alternative data. Because of the standard network interface, which in general is a combination of a network adapter and a corresponding software driver, the stream of data can be accessed easily. Thus means make it possible for a processing unit to access the stream of data. The processing unit examines the data traffic and in the case of a faulty request by the client, the processing unit will block the responses and replace them with alternative data. Instead of the original answer alternative data will be sent to the client over the network-interface.

The alternative data are be selected as sensible alternatives to the faulty requests. This is done by accessing a data-base to determine which alternatives are appropriate. In this way the alternative data will most closely match the interests of the user. For example, typing errors and misspellings will be taken into account when searching for alternative addresses. The alternative data will mainly be names of domains, alternative IP addresses, alternative URLs, HTML-Code or data which is already on the internet like advertisement banners. In order to do efficient searches, well known search engines from the internet will be used. The customer's computer will most commonly be a PC. The PC runs the clients programs such as the web browser, a FTP client, or a gopher client. Of course other programs are also conceivable. The invention can use the Domain-Name-Server, or a web server, or any server which retrieves data on the internet.

### BRIEF DESCRIPTION OF THE DRAWINGS

FIG. 1 is a block diagram of a network. shows the internet with an error scanner, which utilises a data-base, and which is located between the web server and the client's computer, in addition the data-base will access another ad-server.

FIG. 2 is a flow diagram illustrating the operation of the process used in connection with a network..

### DETAILED DESCRIPTION OF THE INVENTION

The task of the invention is to make available an apparatus and a process which extracts and classifies error messages. This is done in order to replace the error message with alternative data such as alternative addresses, advertisement banners, etc. The apparatus being discussed can also be integrated in other areas. The integration in a proxy, and/or the integration into a DNS server, and/or the integration into the client's computer are all conceivable.

In the case that the server can not process the searches of a client, all of the client's searches are recorded. This is done in order to reconstruct a request if an error message is sent. Inquiries to the data-base are thus simplified. In this way alternative data can easily be found.

A further component of this invention is the process according to the independent claims. In the first step the data exchange is analysed between the server and the client. In a second step the responses to the faulty requests are blocked. In the third step alternative data are chosen in regards to the answer from the server, or the form of the search. In a fourth step the alternative data are sent to the client, not the original message from the server. In this way the user will have no idea that an error occurred. Instead the user receives support in finding the correct address. The alternative data are loaded from a data-base depending on the nature of the search. In this way mainly alternatives to the faulty requests are loaded, especially corrected internet addresses. The alternatives are determined by a data-base, such as a well known search engine on the internet.

The internet usage by the client, on the kinds of computers and computer programs that the client uses, matches the characteristics of what the apparatus has to offer. This invention would work for a client who uses a web browser, a FTP client, and/or a gopher client.

The nature of a server also matches the abilities of this apparatus. This apparatus can handle servers like the DNS server, a web server, or other servers which retrieve data on the internet.

This process that has been described can be integrated into many other processes. The integration into a proxy process, and/or the integration into a Domain-Name-Server(DNS) process, and/or the integration onto the computer of the client, are all imaginable. For retrieval of alternative data, the client's searches are recorded. This is done to match the error codes of the server to the searches. In order to search for alternative data the searches are sent to a data-base.

The alternative data will be alternative domain names, alternative IP addresses, alternative URLs, HTML-code, and/or data that is provided by the internet like ad banners. There could be different types of replacement data such as pictures, texts, audio and/or video material, etc.

These processes will mainly be run by computer programs which function on conventional servers and PCs. If the apparatus determines there to be an error in the stream of data, the apparatus will compare the nature of the error and that of the search. Depending on the type of error, the error filter could have different reactions. If the user enters a false internet address, like MICROSOF.COM, an error message will occur which says, ‘DNS name lookup failure’, or ‘site not found’. This apparatus provides the user with alternative data, such as alternate internet addresses. At the same time it loads an ad banner. The alternate internet addresses will be determined by algorithms which are fault tolerant. There are already such search engines on the internet.

If a DNS server produced an error message, this message would be blocked by the invention and replaced by an IP address. The IP address represent the first alternative data. The client's computer program uses the alternative data in order to establish a contact with the servers representing these IP addresses. This substitute server generates a second piece of replacement data, based mainly on the IP addresses of the client's computer. This second piece of replacement data is most often a web page if the client is using a web browser. In most cases the IP addresses of the substitute server correspond to the addresses sent by the error scanner. The error scanner also has a web server. Thus it is possible for the web server to fall back on the analysis of the error scanner. The searches from the client's computer are especially important to analyse. In this way a knowledge of the original search can be gained. On account of this knowledge it is possible to produced an individualised, second piece of alternative data, in general the HTML-page.

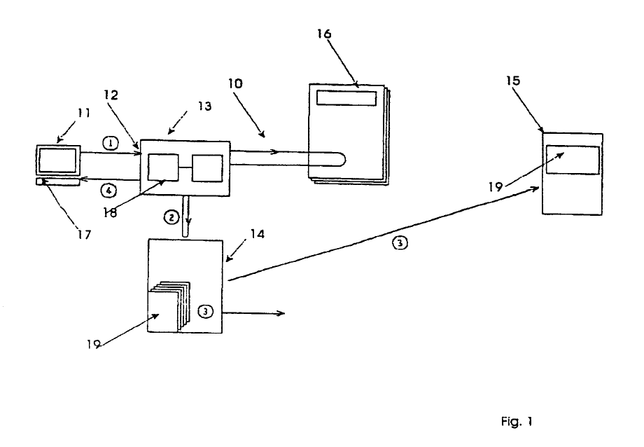

FIG. 1 shows a network 10 (like the internet), which is connected to a client computer 11 and an error scanner 13. The error scanner 13 is located between a web server 16 and the client's computer 11. The error scanner checks if there a fault-answers to requests sent by the client. If an error was to be found, the error message would be blocked and replaced by the alternative data 19.

That is, the alternative data will be determined by data received from a data-base 14. The data-base utilises an additional-information-server 15. This server for additional information 15 deals mainly with different kinds of ad banners. However, the additional-information-server 15 can also be a common search engine of the internet.

The error scanner 13 shows a network interface 12, which allows the error scanner 13 to read data from the network 10. In addition the error scanner 13 shows a processing unit 18 which analyses the requests and the responses from the server for users of the internet.

A program 17 which retrieves data, i.e. a web browser, is the main program which runs on the client-computer. There are other options one can use besides a web browser. The client computer 11 is most often a PC.

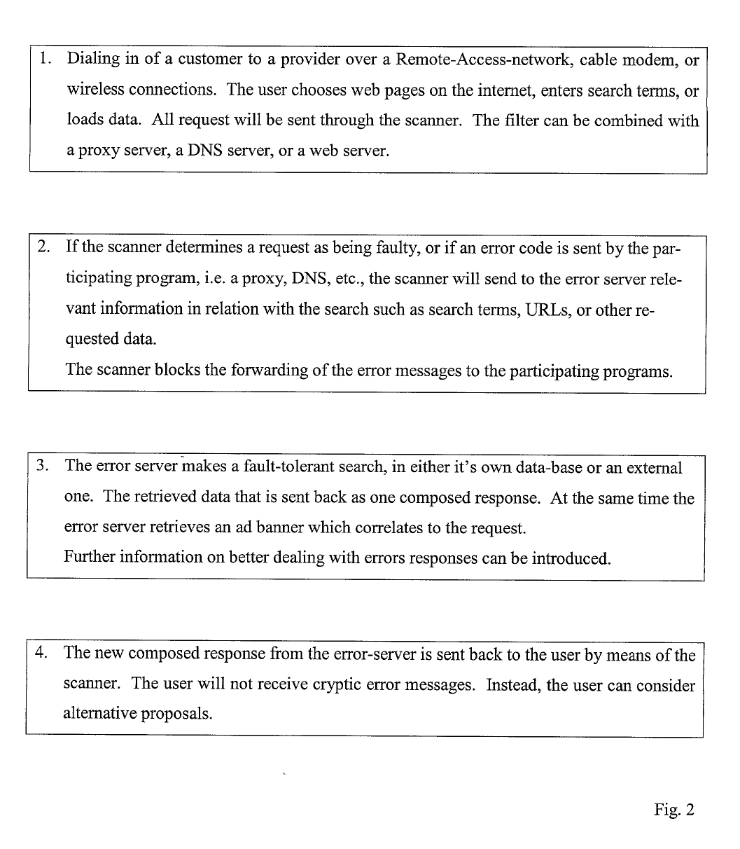

FIG. 2 describes, in detail, the processes, which are implemented by the error scanner. At block 1 a customer dials in to a provider over a remote access network, via wired or wireless connections. When requesting web pages, entering search terms, or loading data, the requests are sent through the error scanner, which can be combined with a proxy server, a DNS server, or a web server.

At block 2 the scanner determines whether a request is faulty, or if an error code is sent by the participating program (such as a proxy, DNS. etc.). If so the scanner sends to the error server relevant information in relation to the search such as search terms, URLs, or other requested data and the scanner blocks the forwarding of the error message(s) to the participating program(s).

At block 3 the error server makes a fault tolerant search in a local or external database. The retrieved data is sent back as one composed response. In addition, the error server retrieves an ad banner which correlates to the request. Further techniques on dealing with error response can be introduced without departing from the scope of the present invention.

At block 4 the new composed response from the error-server is sent back to the user by means of the scanner. The user will receive alternative proposals instead of cryptic error messages.

### List of Reference Numerals

10. Network (e.g. internet)
11. Client Computer
12. Network-Interface
13. Error-Scanner
14. Data-Base
15. Additional-Information-Server; Banner-Server
16. Web-Server with Web-Site
17. Information Request Program, Browser
18. Processing Unit
19. Alternative Data

We claim:

1. An apparatus for a retrieval of alternative data in the case of a faulty request of a client to a server in a packet-based network,
a. with a network interface which enables a data stream between the client and the server to be analysed,
b. with a processing unit which checks the data stream following the request of the client, wherein a data pattern that indicates an error message from the server is blocked and replaced by alternative data, wherein said alternative data depends on the content and type of request, wherein said alternative data will be sent to the client using the network interface.

2. An apparatus for a retrieval of alternative data, in particular a proxy, in the case of a faulty DNS or URL request of a client to a server in a IP network,
a. with a network interface which enables a IP data stream between the client and the server to be analysed,
b. with a processing unit which checks the data stream following the DNS or URL request of the client, wherein a data pattern that indicates an error message from the server is blocked and replaced by alternative data, wherein said alternative data is an IP address or a HTML page depending on the content and type of request, wherein said alternative data will be sent to the client using the network interface.

3. The apparatus of claim 1 or claim 2, wherein said alternative data will be loaded from a database, and wherein said alternative data is determined by searches on the nature, content, and/or type of the request.

4. The apparatus of claim 3, wherein said database is a common search engine in the internet.

5. The apparatus of claim 1 or claim 2, wherein said client is a client-computer, which is equipped with a client program, like a web browser, an FTP client, and/or a gopher client, and wherein said server is a Domain-Name-Server, a web server, an FTP server, or a gopher server.

6. The apparatus of claim 1 or claim 2, wherein said apparatus is integrated in a proxy, and/or a DNS server, and/or in a client-computer.

7. The apparatus of claim 1 or claim 2, wherein the client's request is recorded to determine said alternative data by a search in said database, and wherein information of the recorded request is used.

8. The apparatus of claim 7, wherein said alternative data can be alternative domain names, IP addresses, URLs, and/or data from alternative internet servers such as ad-servers, wherein in the case of a faulty DNS request the error message will be replaced by an IP address, and wherein said IP address refers to a second server which provides a second, more specific piece of alternative information.

9. The apparatus of claim 8, wherein said second server will serve the second alternative data depending on the replaced IP address or depending on the IP address, which shows up on the client's computer.

10. A process, for the retrieval of alternative data in the case of a faulty request of a client to a server in a packet-based network,
a. with a step in which a stream of data between said client and said server is analysed,
b. with a further step in which an error message from said server caused by a faulty request of said client is blocked,
c. with a further step in which alternative data is produced, depending on the nature and/or content of said request,
d. with a further step in which said alternative data, not the server's original response, will be sent to the client.

11. A process, in particular used by a proxy, for the retrieval of alternative data in the case of a faulty DNS request or URL request of a client to a server in a IP network,
a. with a step in which data packets between said client and said server are analysed,
b. with a further step in which an error message from said server in the case of a faulty request by the client is blocked,
c. with a further step in which alternative data in form of an IP address or a HTML page is produced, wherein the alternative data depends on the nature and/or content of said request,
d. with a further step in which said alternative data, not the server's original response, will be sent to the client.

12. The process of claim 10 or claim 11, wherein the alternative data is loaded from a data-base, wherein the search is based on information about the request, and wherein the data-base can be based on a common search engine in the internet.

13. The process of claim 10 or claim 11, wherein the client is a computer, which is equipped with a web browser, FTP client, and/or gopher client, and wherein the server is a DNS server, a web server, and/or a gopher server.

14. The process of claim 10 or claim 11, characterized by an integration into a proxy-process or a DNS-resolution-process.

15. The process of claim 10 or claim 11, wherein the request is recorded to enable the search for alternative data based on the recorded information.

16. The process of claim 10 or claim 11, wherein an error message from a DNS server in response to faulty request will be replaced by an IP address, wherein said IP address refers to a certain error-server, which serves depending on the nature and content of the request a second, more specific piece of alternative data.

17. The process of claim 16, wherein the second, more specific alternative data is related to the IP address of the error-server, wherein the error-server is multihomed, or the more specific alternative data is related to the IP address, which shows up on the client's computer.

18. Computer readable disk, characterized by a computer loadable data structure, that enables the computer to execute the processes described in claim 10 or 11.
